(19) United States
(12) Patent Application Publication
(10) Pub. No.: US 2010/0039833 A1
(43) Pub. Date: Feb. 18, 2010

(54) POWER SUPPLY CONTROL SYSTEM

(75) Inventors: David Robert Coulson, Bedfordshire (GB); Philip John Moyse, Bedford (GB)

Correspondence Address: KNOBBE MARTENS OLSON & BEAR LLP, 2040 MAIN STREET, FOURTEENTH FLOOR, IRVINE, CA, 92614, US

(73) Assignee: Cambridge Semiconductor Limited, Cambridge Cambridgeshire (GB)

(21) Appl. No.: 11/722,511

(22) PCT Filed: Dec. 13, 2005
(86) PCT No.: PCT/GB2005/050242

§ 371 Date: Nov. 5, 2009

Related U.S. Application Data
(60) Provisional application No. 60/646,889, filed on Jan. 25, 2005.

(30) Foreign Application Priority Data
Dec. 21, 2004 (GB) 0427894.1

(51) Int. Cl. H02M 3/335

(52) U.S. Cl. 363/21.05

(57) ABSTRACT

This invention relates to improved control systems and methods for switch mode power supplies. A control system for a switch mode power supply (SMPS), the SMPS having a input side for receiving a power supply input and an output side for providing a dc output voltage, said input and output side of said SMPS being coupled by a transformer, the control system having two operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer, said control system having a feedback input to receive a said feedback signal, a control output for regulating said output voltage, and a mode selector coupled to said feedback input to select one of said first and second control system operating modes responsive to said feedback signal.

This invention relates to improved control systems and methods for switch mode power supplies. A preferred embodiment of the present invention is referred to by the inventors as “LeftBrane”.

A generalised switch mode power supply comprises an energy transfer device for transferring energy cyclically from an input to an output of a power supply (in a flyback regulator design), a switching device coupled to the input of the power supply and to the energy transfer device, and a control system for controlling the switching device in response to a feedback signal to regulate the output voltage of the power supply by regulating the energy transferred per cycle. The switch has two states, a first state in which energy is stored in the energy transfer device, and a second state for transferring the store energy to the power supply output. Typically the energy transfer device comprises an inductor or transformer and the switching device is controlled by a series of pulses, the transfer of power between the input and the output of the power supply being regulated by either pulse width modulation or pulse frequency (period) modulation. The data sheet for the iWatt iW2201 power supply controller also describes pulse “density” or rate modulation (which is similar to pulse Frequency modulation).

There are many ways of deriving a feedback signal for the control system to regulate the power supply—for example if a transformer is used as the energy transfer device an additional or auxiliary winding on the transformer can be used to sense the reflected second voltage, which approximates to the power supply output voltage. Alternatively some form of more direct feedback from the power supply output may be employed, generally in the case employing some form of isolation between the output and input such as an opto-isolator or pulse transformer.

In this specification we will refer to two modes of operating a switch mode power supply control system, a static mode in which feedback is from the secondary or output side of the power supply, typically monitoring the dc output voltage or some other secondary side voltage dependent thereon, and a dynamic mode which infers a voltage at the output side of the power supply by sensing the state of the energy transfer device, for example by using an auxiliary winding as described above.

Background prior art relating to dynamic mode sensing can be found WO 03/047079, US 2003/0132739, US 2003/0128018, US 2004/0037094, US 2004/0052095, US 2002/0001204, U.S. Pat. No. 4,975,823, U.S. Pat. No. 5,936,852 and JP03/265462A.

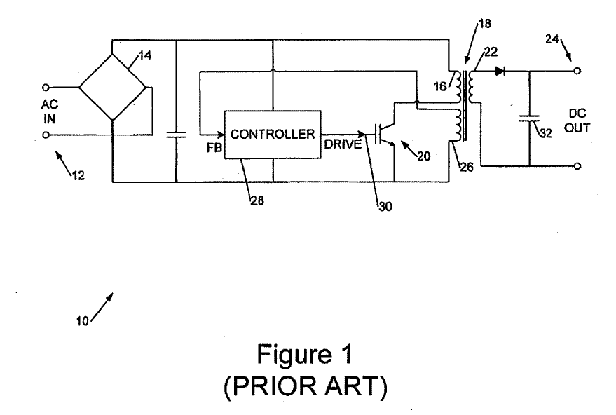

FIG. 1 shows an example of a switch mode power supply circuit (10). This comprises an AC mains input 12 coupled to a bridge rectifier 14 to provide a DC supply to the input side of the power supply. This DC supply is switched across a primary winding 16 of a transformer 18 by means of a switch 20, in this example an insulated gate bipolar transistor (IGBT). A secondary winding 22 of transformer 18 provides an AC output voltage which is rectified to provide a DC output 24, and an auxiliary winding 26 provides a feedback signal voltage proportionally to the voltage on secondary winding 22. This feedback signal provides an input to a control system 28, powered by the rectified mains, this control system providing a drive output 30 to switching device 20, modulating either pulse width or pulse frequency to regulate the transfer of power through transformer 18, and hence the voltage of DC output 24. Broadly speaking, when switch 20 is on the current in primary winding 16 ramps up storing energy in the magnetic field of transformer 18 and then when switch 20 is opened there is a steep rise in the primary voltage (and hence also in the secondary voltage) as the transformer attempts to maintain its magnetic field; the spikes in the secondary voltage are smoothed by a smoothing circuit, typically an output capacitor 32.

When switch 20 is opened there is some initial high frequency noise and ringing in the secondary voltage after which this settles down to an approximately constant (but slightly decaying) plateau whilst the secondary current ramps down to zero. As the secondary current approaches zero the plateau voltage reaches a knee where it falls off steeply to zero; this is then followed by further ringing resulting from self resonance in the transformer in combination with stray capacitance including the off-capacitance of the switch. The output voltage is approximately equal to the plateau voltage of the secondary less a diode drop and resistance losses. These losses are most accurately determined by measuring the plateau voltage shortly before the knee, as described in the prior art, for example US 2004/0052095 (paragraphs 49 to 60 of which hereby incorporated by reference), for example, by measuring back a fixed time off set from the point at which the secondary voltage falls to zero.

Separately to the above-described static and dynamic mode circuit configurations switch mode power supplies are commonly described as working in either a continuous conduction mode (CCM) or in a discontinuous conduction mode (DCM). In DCM the energy stored in the energy transfer device falls to substantially zero between power switching cycles; where the energy transfer device comprises a transformer then the secondary current goes to approximately zero between each cycle. By contrast in CCM the energy transferred in one cycle depends upon that transferred in previous cycles, and where the energy transfer device comprises a transformer the secondary current rarely or substantially never falls to zero. A critical conduction mode is also sometimes referred to in which, to the arrangement of FIG. 1, switch 20 is closed just as the secondary current (stored energy) falls to zero, so that the secondary or output side diodes only stops conducting for an instant. Applications of the prior art switch mode power supply control arrangements referred to above are restricted to DCM and critical conduction mode operation.

A control system for a switch mode power supply capable of operating in both discontinous (DCM) and discontinuous (CCM) conduction modes would be of benefit.

According to a first aspect of the present invention there is therefore provided a control system for a switch mode power supply (SMPS), the SMPS having a input side for receiving a power supply input and an output side for providing a dc output voltage, said input and output side of said SMPS being coupled by a transformer, the control system having two operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer, said control system having a feedback input to receive a said feedback signal, a control output for regulating said output voltage, and a mode selector coupled to said feedback input to select one of said first and second control system operating modes responsive to said feedback signal.

Broadly speaking, therefore, the first operating mode of the control system corresponds to the above described static mode and the second operating mode to a dynamic operating mode. Preferably the control system is implemented digitally and operates on a per power switching cycle basis, that is re-evaluating the control output each power switching cycle. In embodiments automatic detection and selection of static and dynamic operating modes to support primary and secondary (input and output) side sensing modes facilitates provision of a versatile control system, for example as an integrated circuit, which may easily be incorporated into a wide variety of different switch mode power supply designs.

In preferred embodiments the feedback signal is digitised and the first or static mode is selected if no transition in the digitised signal are detected for a number of power switching cycles. The presence of oscillations in the feedback signal or transitions in the digitised signal can be used to select the second or dynamic mode. Additionally or alternatively the dynamic mode may be set by comparison of the feedback signal with respect to a zero voltage reference level since the ringing in the secondary output voltage after this has fallen to zero is reflected back to the auxiliary winding and can thus drive the feedback signal below nought volts.

In preferred embodiments the control output is responsive to a value of the feedback signal at a sampling time and the control system is configured to select the sampling time responsive to the operating mode. Preferably in the static mode the feedback signal is sampled at a time when a current in an input or primary side winding of the transformer is at or near it's peak value. In the dynamic mode the feedback signal is preferably sampled at a time having a substantially fixed backwards offset from a time when a current in an output or secondary side winding of the transformer is substantially zero. The backwards offset need not necessarily be fixed but since the frequency of the ringing does not change there is no need to vary the offset. In static mode the time for sampling the feedback signal (or a signal derived from this) may be determined from a drive signal driving a switching device, as previously described, switching power to the input or primary side winding of the transformer.

In preferred embodiments the control output comprises a digital signal output, for example a bus, and the feedback signal is digitised prior to sampling. More particularly the sampled digitised feedback signal is preferably derived from a comparison of the feedback signal with a reference level (this reference level may take account of diode and other losses in the secondary or output side of the power supply). In particularly preferred embodiments the control system also includes a current sense input to receive a current sense signal which is combined with the feedback signal for the comparison so that the comparator in effect makes a comparison of the feedback signal plus a current sense signal with the reference (although in embodiments, for convenience, the actual comparison may be between a combination of a voltage reference and current sense signal and the feedback signal, to achieve the same overall effect. Preferably the current sense signal is responsive to a current following in the switch mode power supply input side to provide power to the energy transfer device (or transformer) during the first part of a power switching cycle. The current sense signal may comprise, for example a voltage across a current sense resistor in the primary circuit of the transformer.

Thus in another aspect the invention provides a control system for a switch mode power supply (SMPS), the SMPS having an input side for receiving a power supply input and an output side for providing a dc output voltage, said input and output sides of said SMPS being coupled by an energy transfer device, said control system having a feedback input to receive a feedback signal responsive to said dc output voltage, and a control output for regulating said output voltage, said control system further comprising a current sense input to receive a current sense signal, and wherein said control system is configured to output a control signal dependent upon a combination of said feedback signal and said current sense signal for regulating said output voltage.

Preferably the control system is configured such that the switch mode power supply operates in a continuous induction mode. Preferably, as previously mentioned, a digital signal is generated internally by comparing a combination of the feedback signal, current sense signal and a reference level to, in effect, determine whether the feedback signal plus a proportion of the current sense signal is greater or less than a reference value. This provides a digital, preferably 1 bit value which may be sampled at intervals to determine whether more or less energy is to be supplied to the energy transfer device each power switching cycle. Optionally the length of a pulse of this digital comparator output may be employed additionally or alternatively to determining whether the combination of the feedback signal and current sense signal is above or below the reference level at a sampling time.

In a related aspect the invention also provides a method of controlling a switch mode power supply (SMPS), the SMPS having an input side for receiving a power supply input and an output side for providing a dc output voltage, said input and output sides of said SMPS being coupled by an energy transfer device, the method comprising: receiving a feedback signal responsive to said de output voltage; receiving a current sense signal responsive to a current flowing in said SMPS input side and providing power to said energy transfer device; and controlling said SMPS output voltage responsive to a combination of said feedback signal and said current sense signal.

The invention further provides a control system for a switch mode power supply, the SMPS having a input side for receiving a power supply input and an output side for providing a de output voltage, said input and output side of said SMPS being coupled by a transformer, the control system having a feedback input to receive a feedback signal (FB) responsive to a voltage in said output side of said SMPS, and a control output to provide a control signal (DEMAND) for regulating said dc output voltage, the control system further comprising a first comparator coupled to said feedback input to compare a signal from said feedback input with a first reference level to provide a first digitised signal (FLY), and a second comparator with a second reference level to provide a second digitised signal (FBD), and a control system to provide said control signal responsive to said first and second digitised signals.

As previously mentioned the feedback signal may be derived either statically, for example from the dc output power supply, preferably using some form of isolation, or dynamically, for example from an additional or auxiliary transformer winding. In preferred embodiments the control system further comprises a first store or fifo coupled to an output of the first comparator to store a history of the first digitised signal, the sampling time being dependent upon this history. This may be used to identify transitions for selecting a static or dynamic mode of operation and may also be used in the determination of dynamic mode sample timing. A similar store or fifo is preferably also provided for the second comparator (the FBD signal) since this facilitates going back in time from an edge of the first digitised signal (FLY) in a dynamic mode of operation as the FLY edge is later than the FBD edge. Further preferably, as previously mentioned, the feedback signal is combined with the signal from a current sense input to generate the second digitised signal.

The invention further provides a switch mode power supply (SMPS) controller for a SMPS having an input side for receiving a power supply input and an output side for providing a dc output voltage, said input and output sides of said SMPS being coupled by a transformer, the controller having two operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer.

In a related method the invention provides a method of implementing a control system for a switch mode power supply (SMPS), the SMPS having a input side for receiving a power supply input and an output side for providing a dc output voltage, said input and output side of said SMPS being coupled by a transformer, the method comprising: providing two control system operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer; receiving a said feedback signal; selecting one of said first and second control system operating modes responsive to said feedback signal; and outputting a control signal for regulating said SMPS output voltage to implement said control system in accordance with said selected operating mode.

Aspects of the invention also provide a control system for a switch mode power supply configured to operate in accordance with the above described methods and including means for implementing these methods.

The above described control systems and signal processors may be implemented in dedicated hardware including, for example, an integrated circuit such as an ASIC (application specific integrated circuit) or FPGA (field programmable gate array) or in software, or in a combination of two.

Thus in a further aspect the invention provides processor control code, in particular on a carrier, for implementing the above described control systems and signal processor. The carrier may comprise any conventional data carrier such as a disk, CD- or DVD-ROM, programmed memory such as read only memory (firmware) or a data carrier such as an optical or electrical signal carrier. The processor control code may comprise a code and/or data in a conventional programming language such as C, or microcode, or code for setting up or controlling an ASIC or FPGA, or RTL code, or code for a hardware description language such as Verilog (trademark), VHDL or SystemC. As the skilled person will appreciate such code and/or data may be distributed between a plurality of coupled components in communication with one or other.

Broadly speaking in embodiments of the invention a combination of two signals, a feedback signal (derived from the transformer auxiliary primary winding) and a current sense signal (derived from a current sensing resistor) from the switch mode power supply circuit are compared with a voltage reference to produce a digital demand signal indicating whether more or less power is to be transferred per switching cycle from the input to the output side of the power supply. This demand signal can be used to control a switching signal to a switching device switching power to the transformer, thereby providing overall loop control. The controller selects either a static or dynamic feedback mode by monitoring the activity of a digitised version of the feedback signal, thereby altering the sample timing of a second digitised version of the feedback signal to produce the demand signal. The second digitised version of the feedback signal is derived by comparing a combination of the feedback on current sense signals with a reference. In the static mode the second version of the feedback signal is sampled at the end of the switch ON period so that the value of the peak primary current is included in the feedback term. In a dynamic mode the second version of the digitised feedback signal is sampled at the end of the flyback period when both the primary and secondary currents are approximately zero.

The various above described aspects of the invention may be combined in any permutation.

These and other aspects of the present invention will now be further described, by way of example only, with reference to the accompanying figures in which:

FIG. 1 shows a generalised example of a switch mode power supply;

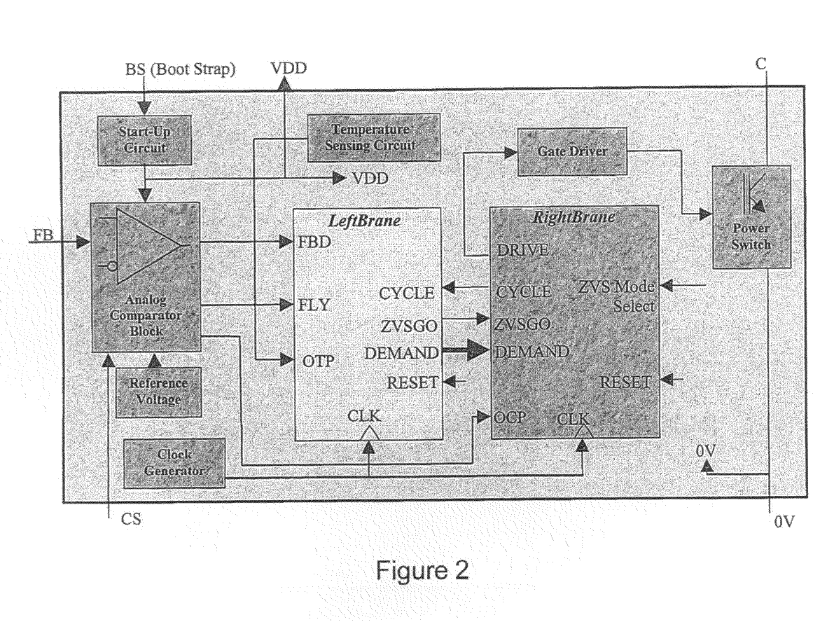

FIG. 2 shows an overview of a power integrated circuit (IC) embodying aspects of the present invention;

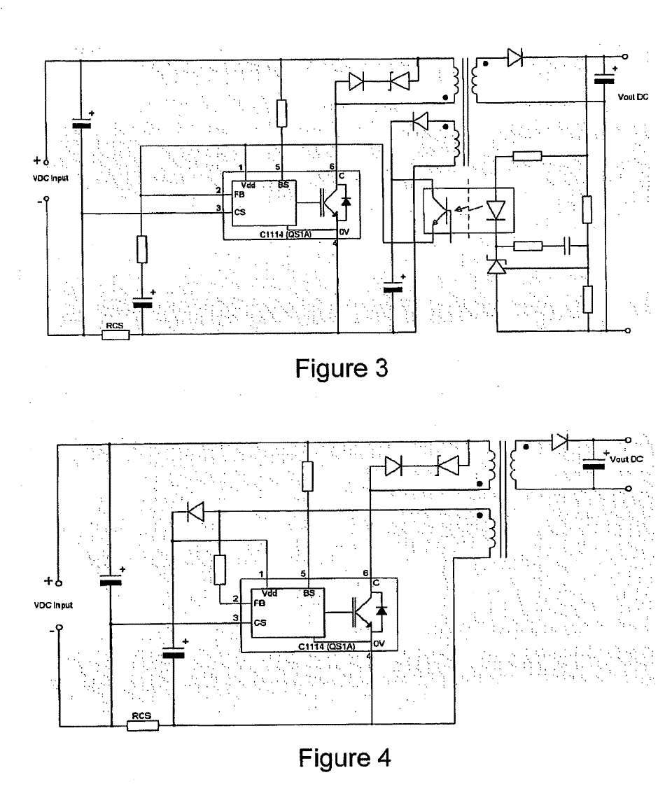

FIG. 3 shows a first example application of an embodiment of the invention, with static mode secondary regulation;

FIG. 4 shows a second example application of an embodiment of the invention, with dynamic mode primary side regulation;

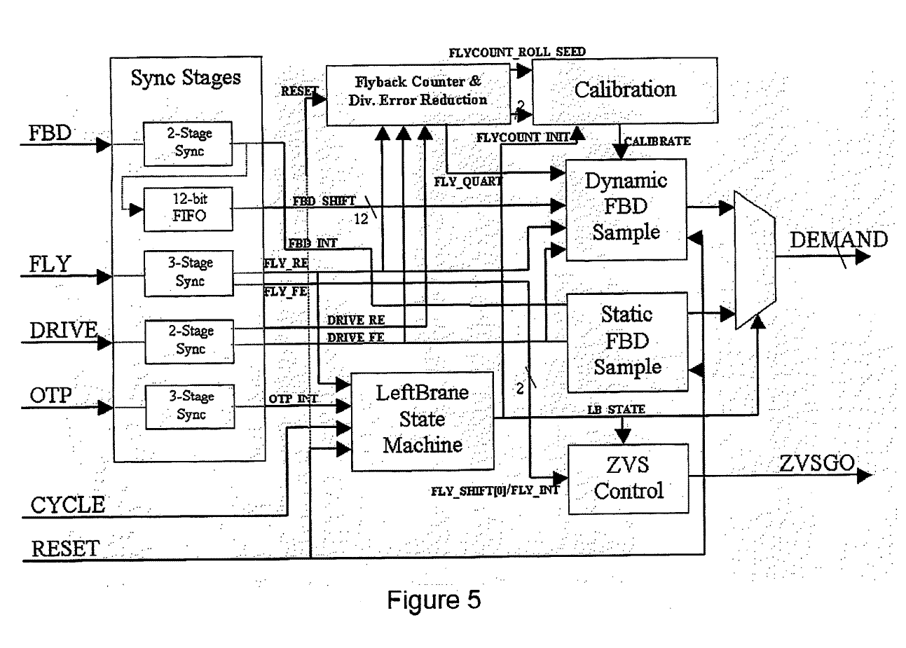

FIG. 5 shows an overview of a “LeftBrane” system;

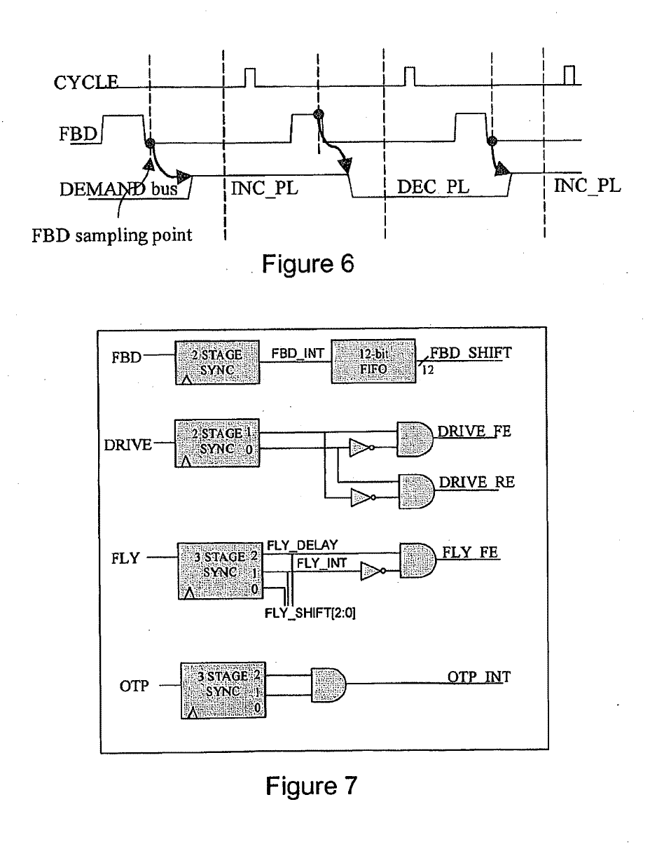

FIG. 6 shows FBD sampling-to-DEMAND bus timing;

FIG. 7 shows LeftBrane synchronising stages;

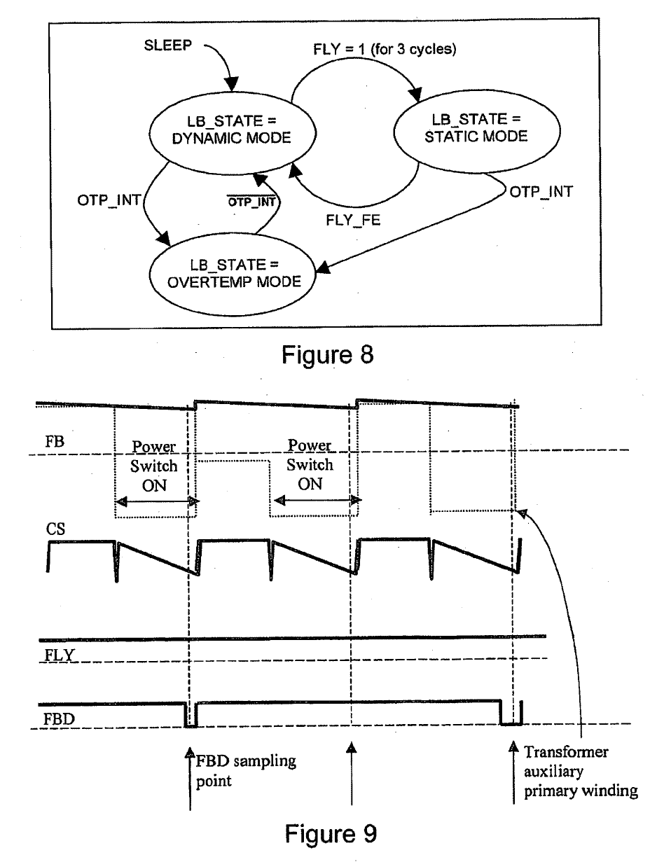

FIG. 8 shows a LeftBrane operating mode state machine;

FIG. 9 shows static mode operation with FBD sampling;

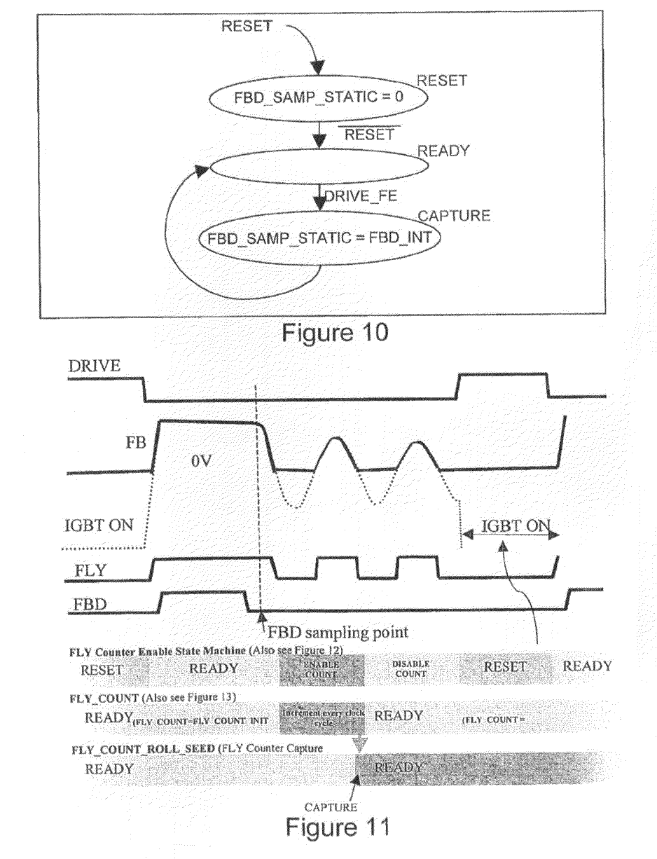

FIG. 10 shows a static feedback capture state machine;

FIG. 11 shows dynamic mode operation FBD sampling showing FLY_COUNT;

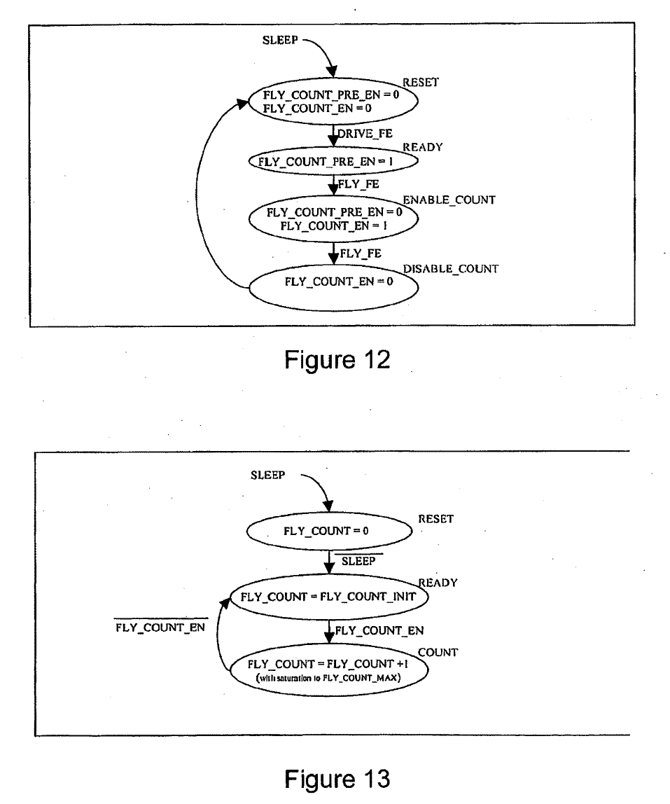

FIG. 12 shows a FLY counter enable state machine;

FIG. 13 shows a flyback oscillation period counter;

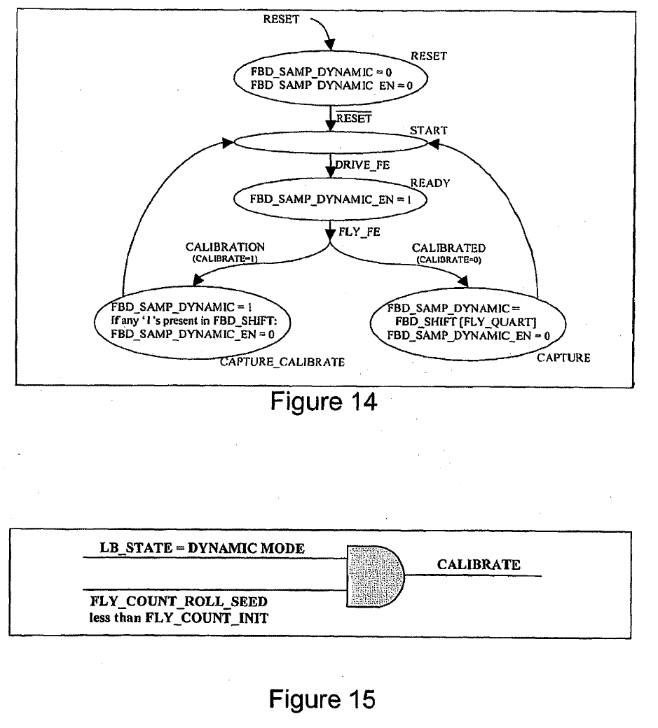

FIG. 14 shows a dynamic feedback capture state machine;

FIG. 15 shows a circuit for CALIBRATE signal generation;

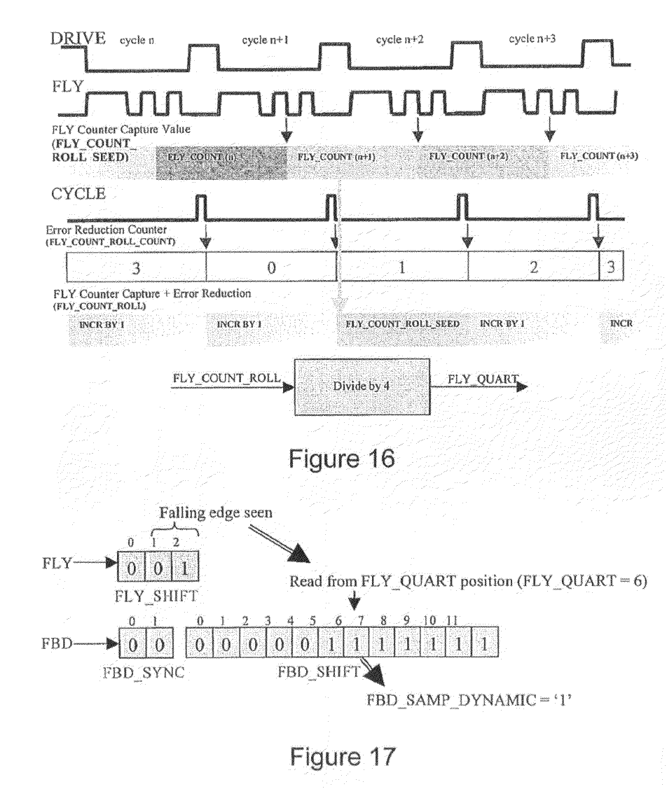

FIG. 16 shows FLY count capture and error reduction;

FIG. 17 shows Dynamic FBD capture registers;

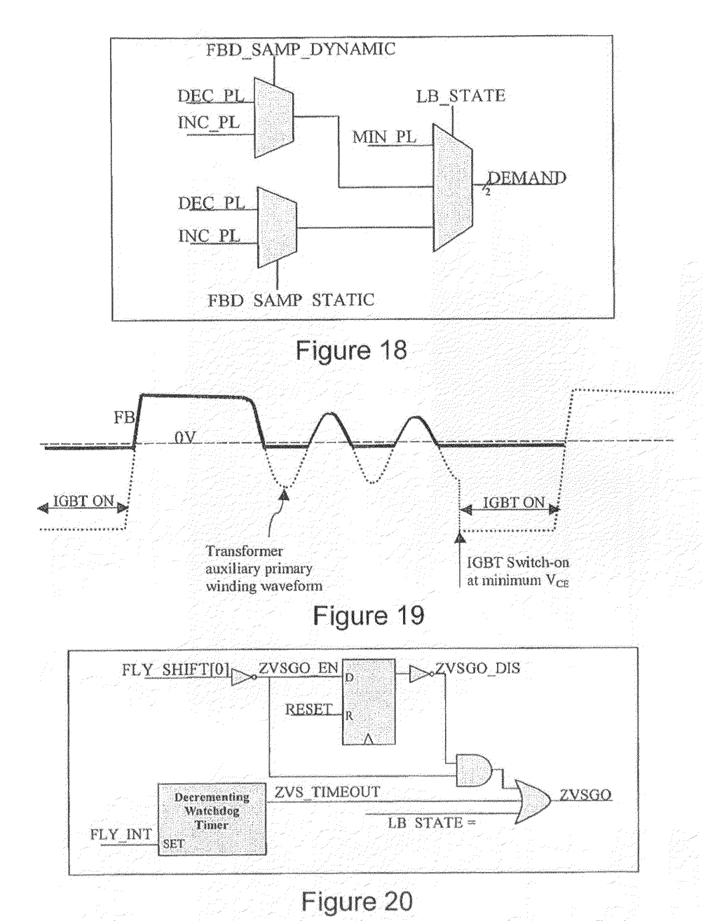

FIG. 18 shows an assignment to DEMAND circuit;

FIG. 19 shows an FB (feedback) waveform in dynamic mode for ZVS (zero-voltage switching) control;

FIG. 20 shows QZVS (quasi zero-voltage switching) enable logic;

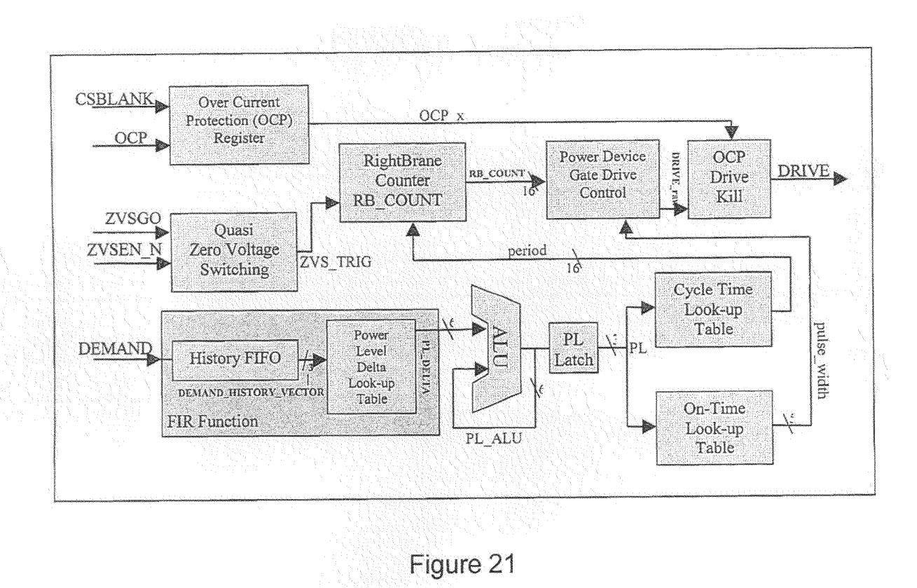

FIG. 21 shows an overview of a “RightBrane” system;

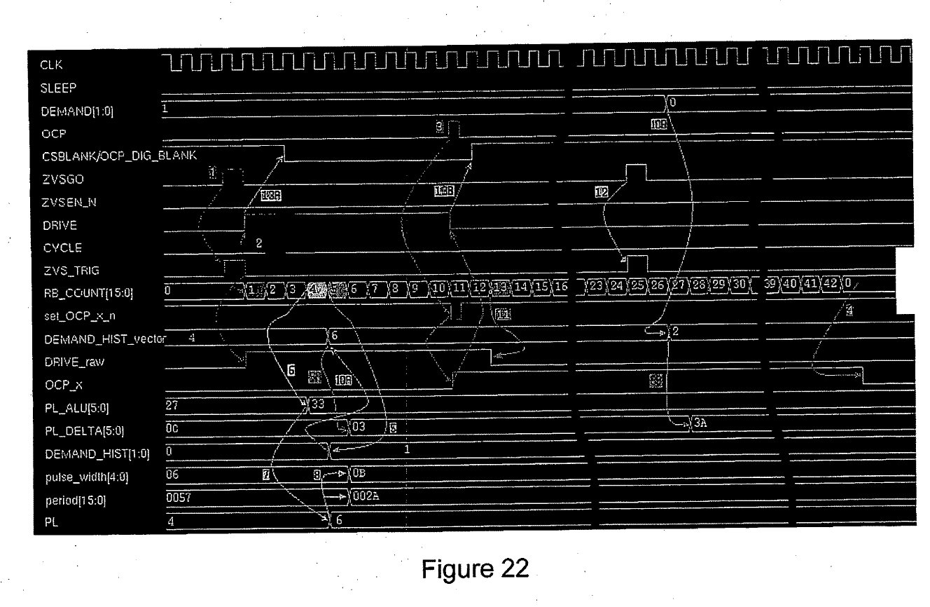

FIG. 22 shows “RightBrane” system timing;

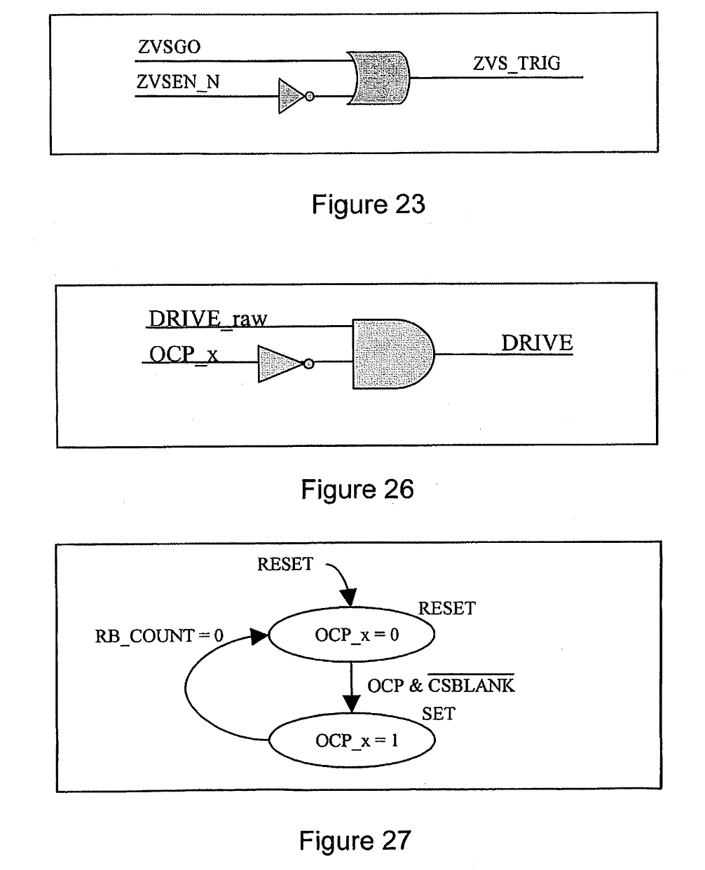

FIG. 23 shows a quasi zero-voltage switching enable circuit;

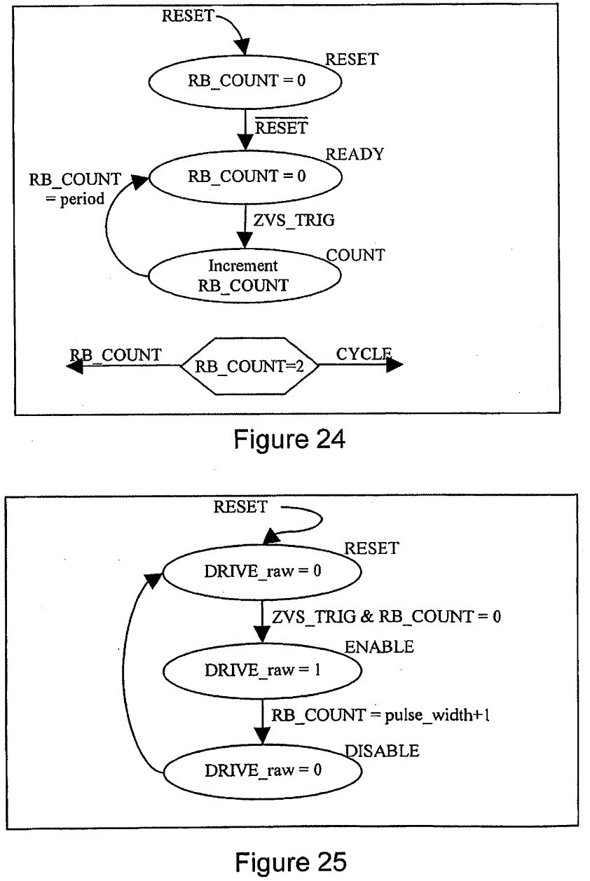

FIG. 24 shows switching cycle counter operation;

FIG. 25 shows DRIVE_raw pulse generator operation;

FIG. 26 shows a circuit for DRIVE disabling by an output of an over-current protection latch;

FIG. 27 shows asynchronous over-current protection latch operation;

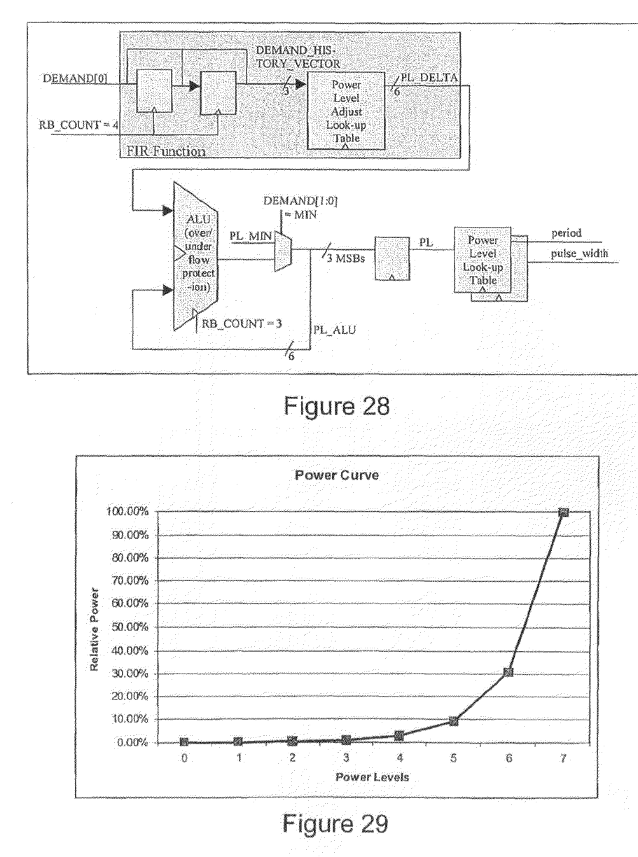

FIG. 28 shows a RightBrane power level calculation circuit; and

FIG. 29 shows a graph of relative power against power level for an embodiment of the present invention.

Aspects of the invention will now be described detail by describing a circuit referred to by the inventors as “LeftBrane”, which is a preferred embodiment of the present invention.

The present invention forms a key part of a circuit used to control a switch mode power supply (SMPS) system. Typically, this invention will be implemented as part of a Power Integrated circuit as shown in FIG. 2, along with other components.

FIG. 2 shows LeftBrane, an embodiment of the present invention located within a complete Power Integrated Circuit. LeftBrane and another circuit we refer to as RightBrane (also shown in FIG. 2) together form a complete digital SMPS controller.

RightBrane is described in full after the description of LeftBrane to help provide a complete description of a control system of which a preferred embodiment of the present invention is a constituent part. Optionally a “BraneScan” module (not shown in FIG. 2 for clarity) may also be included to allow activation (overriding) of internal control signals to facilitate testing.

The overall purpose of the LeftBrane is to collate and analyze feedback data from the switch mode power supply supplied to it via a number of analog comparators. The result of this analysis is passed onto the RightBrane in the form of a DEMAND signal (typically, for example, a binary signal) which indicates whether more or less power should be supplied to the switch mode power supply.

In this detailed description of an embodiment of the present invention we will refer (as mentioned above) to two modes of operating a switch mode power supply control system, a Static mode in which feedback is from the secondary or output side of the power supply, typically monitoring the dc output voltage or some other secondary side voltage dependent thereon, and a Dynamic mode which infers a voltage at the output side of the power supply by sensing the state of the energy transfer device, for example by using an auxiliary winding on the primary side.

FIGS. 3 and 4 show example applications of the SMPS integrated circuit of FIG. 2. FIG. 3 shows an example circuit configured to operate in static mode (which employs feedback from the secondary side of the SMPS for regulation). FIG. 4 shows an example circuit configured to operate in dynamic mode of (which employs primary side regulation).

In the example circuits of FIGS. 3 and 4 the current sense resistor R_{CS} is typically set at 330 mΩ but an alternative (greater) value may be calculated from the equation R_{CS}=V_{OCP}/OCP Ohms, where OCP is the required current limit. If the voltage developed across the resistor R_{CS} exceeds V_{OCP} the IGBT is switched off until the start of the next switching cycle and a blanking period (CSBLANK, described later) is preferably implemented to inhibit false triggering of the overcurrent protection at the start of each switching cycle. The remaining component values the example circuits of FIGS. 3 and 4 may be selected in accordance with conventional electronic design techniques as are well known to those skilled in the art.

The LeftBrane circuit will now be described in detail. The functional inputs and outputs of the LeftBrane are shown in Table 1 below.

TABLE 1
LeftBrane Functional Inputs and Outputs
Inputs

| | |
|---|---|
| FBD | Feedback Digital input - threshold crossing |
| FLY | Feedback Digital input - zero crossing |
| OTP | Over Temperature Protection from Temperature Sensing |
| | Circuit |
| CYCLE | Indicates start of new switching cycle to allow |
| | synchronization with RightBrane |
| DRIVE | Output of RightBrane to Power Switch - used by LeftBrane |
| | to help determine correct FBD sampling point |
| CLK | System Clock input |
| RESET | Used as system reset |

Outputs

| | |
|---|---|
| DEMAND | Demand output (to RightBrane controller) |
| ZVSGO | qZVS Enable timing output (to RightBrane) |

The prime function of the LeftBrane is to produce a DEMAND signal (typically, for example, a binary signal) which indicates to the RightBrane (or other control system) whether the output voltage is above or below its target. This informs the RightBrane (or other arrangement) as to whether less or more power needs to be transferred to maintain the correct output voltage. This data is then processed by the RightBrane to determine the appropriate power level. In preferred embodiments of a complete system the DEMAND signal is provided to a RightBrane system which forms another part of the overall control system, but in other arrangements any circuit which is capable of regulating responsive to a DEMAND-type signal may be employed.

FIG. 5 shows a schematic overview of the LeftBrane.

Data derived from the feedback input FB, is provided to the LeftBrane in the form of two signals, FLY and FBD, which indicate the 0V and 5.0V crossings of FB, respectively.

The FBD signal is sampled by the LeftBrane in order to determine whether the power level needs to be increased or decreased. The FLY signal is used to determine when the FBD should be sampled depending on the feedback mode as described below.

All inputs need to be synchronized to the local clock to prevent meta-stability. The FLY and FBD signals are then shifted into FIFOs so that their history is stored.

In either STATIC or DYNAMIC modes, the FBD sampled value controls whether the DEMAND signal should indicate an increase or decrease in power level. If the sampled FBD is high then the DEMAND indicates a decrease, if the sampled FBD is low then the DEMAND indicates an increase. The DEMAND signal changes in time for the next power switching cycle as shown in FIG. 6.

In the present embodiment, DEMAND is implemented as a 2-bit bus, with the least significant bit used to represent the DEMAND state as described above and the most significant bit used to indicate an error condition (Over Temperature) which when active forces the system to the minimum power level. Unless specifically stated, the term DEMAND within this description refers only to the least significant bit. Table 2 shows the meaning of each DEMAND value.

TABLE 2
DEMAND Bus Values

| DEMAND bus | Function | Description |
|---|---|---|
| 00 | DEC_PL | Decrease power level |
| 01 | INC_PL | Increase power level |
| 10 | MIN_PL | Reduce to minimum power level |
| | | (Over Temperature Error) |
| 11 | MAX_PL | Not used |

The LeftBrane Synchronization logic is shown in FIG. 7.

The FBD, FLY and OTP inputs into the LeftBrane come directly from analog (and hence asynchronous) comparators, so need to be synchronised to the digital clock domain. The DRIVE input can be asynchronously cleared in the RightBrane, so also needs to be synchronised into the LeftBrane. The CYCLE input can be used without synchronization, as the LeftBrane and RightBrane operate within the same digital clock domain. The synchronization logic is also used to determine the rising and falling edges of some of these inputs for use in the control algorithm.

After synchronization, The FBD input is shifted into a FIFO (12-bits long in the present embodiment), which forms part of the DYNAMIC mode sampling routine.

FIG. 8 shows how the LeftBrane determines which operating mode it is in. If a falling edge is seen on FLY (indicated by FLY_FE), then the LeftBrane goes into DYNAMIC mode. If FLY remains high for three CYCLE pulses then the LeftBrane goes into STATIC mode. If the synchronized OTP input (OTP_INT) indicates an over temperature state then the LeftBrane goes into Over Temperature Error mode. These modes determine the sampling behaviour of the LeftBrane.

In STATIC Mode, the FBD input is sampled just before the end of the power switch conduction period, as shown in FIG. 9. As a result the FBD signal is active high if V_{FB}+R_{CS}·I_{IGBT} is greater than a threshold, for example 5 volts. The I_{IGBT} term provides cycle-by-cycle current feedback assisting control loop stability; in alternative embodiments a fraction of I_{IGBT} such as I_{IGBT}/10 may be employed.

In practice, this is achieved by sampling FBD_INT when the falling edge of DRIVE is detected and flagged by the DRIVE_FE signal. The paths taken by DRIVE and FBD to generate DRIVE_FE and FBD_INT have matched synchronization delays, so give a good representation of the actual FBD value at the time that DRIVE went low. The delay through the gate driver block helps ensure that the captured value of FBD represents the FB value at the end of the POWER SWITCH conduction period, rather than at the start of the SMPS flyback period. The operation of the state machine managing the sampling of FBD in Static mode is shown in FIG. 10.

When the LeftBrane is in DYNAMIC mode, the FBD sampling point is specified to be ¼ of the flyback oscillation period before the first falling edge of FLY. Typical waveforms for DYNAMIC Mode operation are shown in FIG. 11.

Central to Dynamic mode operation is the ability to measure the resonant frequency of the SMPS flyback. From this measurement a value FLY_QUART, ¼ of the flyback oscillation period can be calculated. In every switching cycle where a full flyback oscillation occurs, the period of that oscillation is measured, between the first and second falling edges of the FLY signal. In practice, a count is initiated on the first falling edge of FLY using a counter FLY_COUNT (6-bits in the present embodiment). If a full oscillation occurs, the final value of FLY_COUNT is loaded into a register FLY_COUNT_ROLL_SEED (again 6-bits in the present embodiment). Note that at higher power levels, a full oscillation may not occur due to DRIVE being asserted, so FLY_COUNT_ROLL_SEED is not updated and the previous value retained. FLY_QUART is essentially FLY_COUNT_ROLL_SEED divided by 4, with an error compensation technique to take any remainder from the division into account. The error compensation mechanism is discussed in more detail later.

The flyback counter increments the FLY_COUNT value every clock cycle, while the flyback counter enable state machine is in the ENABLE COUNT state. On the falling edge of the next FLY, the state machine disables the counter and the count value is transferred into the capture register, FLY_COUNT_ROLL_SEED. If a complete flyback oscillation does not occur, the FLY_COUNT value is discarded. Once the FLY_COUNT value has been transferred or discarded, indicated by the FLY_COUNT_EN signal going inactive, it is reset ready for the next power switching cycle. In the present embodiment, the counter is reset to a non-zero constant FLY_COUNT_INIT, which is set to an appropriate starting value to obtain the optimal measurement of the flyback oscillation period. The flyback counter should be designed to have the capacity to measure the maximum flyback oscillation period, which the overall switch mode power supply can reasonably be expected to encounter. Nonetheless, the flyback counter is equipped with a protection mechanism, which holds the counter at its maximum value, should it be reached, rather than let it roll back over to zero.

The captured value, FLY_COUNT_ROLL_SEED should not significantly change from cycle to cycle, as it is determined by the characteristics of the transformer and other parts of the SMPS system. A +/−1 clock cycle variation may occur due to clock granularity.

State flow diagrams for the Flyback Counter Enable State Machine and Flyback Counter itself are shown in FIGS. 12 and 13 respectively.

The operation of the Dynamic Mode Feedback Capture State Machine is shown in FIG. 14. There are two sub-modes of operation: Calibration and Calibrated. The Calibration sub-mode is deployed until a successful measurement of the flyback oscillation period has been achieved.

A successful measurement will cause the FLY_COUNT_ROLL_SEED value to be greater than the FLY_COUNT_INIT value and indicates that the LeftBrane is no longer calibrating. FIG. 15 shows the circuit used to generate the CALIBRATE signal.

FIG. 14 shows the two sub-modes of operation of the Dynamic Feedback Capture State Machine. In the Calibration sub-mode, the presence of any ‘1’ in the whole of the FBD_SHIFT register at the time of the first falling edge of FLY causes the FBD_SAMP_DYNAMIC signal to be set to ‘1’. This simply indicates that FB has reached its threshold value (5.0V in the present embodiment) during the course of the present switching cycle and allows a simple form of regulation to operate until we have exited the Calibration sub-mode.

Once Calibration has occurred, the circuit must ensure that the value of FBD is correctly captured at a sampling point ¼ of the flyback oscillation period before the first falling edge of FLY. Until the falling edge of FLY, the circuit does not know where this sampling point occurs. To compensate for this, a historical record of FBD is created in the FBD_SHIFT register, which is 12-bits long in the present embodiment. Once FLY_FE indicates that the FLY signal has fallen, the circuit can index back into the FBD_SHIFT register to determine the value of FBD at a time ¼ of a flyback oscillation period prior to the FLY falling edge.

FIG. 16 shows a pattern of DRIVE pulses and the resultant pattern on the FLY signal in Dynamic mode. FLY_COUNT (not shown) begins incrementing on the first falling edge of FLY and continues until the second falling edge of FLY or until a new switching cycle commences. If a complete flyback period is captured, FLY_COUNT_ROLL_SEED is loaded with the FLY_COUNT value. FLY_COUNT_ROLL_SEED is loaded into the divide error reduction counter once every four power switching cycles. It is effectively incremented by 1 each cycle and divided by 4 to give a divide-error-compensated FLY_QUART value.

The effect of the divide error reduction counter is best described with a numerical example, using decimal number values.

Without the divide error reduction counter a flyback oscillation period of for example 23 would result in a FLY_QUART value of 5, that is 23/4 less the remainder. Thus there would be an average error of 0.75 on FLY_QUART. However with the error reduction counter in place, the same starting value of 23 would produce FLY_QUART values of ⁽²³⁺⁰⁾/₄=5, ⁽²³⁺¹⁾/₄=6, ⁽²³⁺²⁾/₄=6, ⁽²³⁺³⁾/₄=6 giving a mean value of 5.75.

The FLY_QUART value is used to index into the FBD shift register, as shown in FIG. 17, as the first FLY falling edge is seen. This is equivalent to reading the FBD value at the sampling point shown in FIG. 11.

As previously stated, a 2-bit DEMAND signal is passed to the RightBrane, determined by the sampled FBD value and the operating state of the LeftBrane module given by the LB_STATE bus. An overview of the circuit which implements this function is shown in FIG. 18.

For Critical Mode Conduction (CRM), the power switch should be turned on again at the trough of the first flyback oscillation. Switching on during subsequent troughs gives pseudo or quasi Zero Voltage Switching (qZVS), which is desirable to achieve high efficiency by minimizing the losses associated with the power switch turn-off transition. This behaviour is shown in FIG. 19. The power switch is turned back on again at a valley point on the FB waveform, which the LeftBrane determines by examining the FLY signal. CRM and qZVS is only available in Dynamic mode as it is reliant on examining transitions on the FLY waveform.

The LeftBrane determines the optimum firing window for DRIVE when in DYNAMIC mode, and passes this information to the RightBrane. The RightBrane will use this information if ZVS Mode is selected, otherwise, it will be ignored. The circuit used to achieve this is shown in FIG. 20. The circuit provides an output signal ZVSGO, which permits the RightBrane to commence a new power switching cycle. Note that in STATIC Mode, ZVSGO is forced permanently high.

In the present embodiment ZVSGO is triggered as soon as the falling edge of FLY is detected within the LeftBrane. Given that there will be a delay due to the gate driver and the ‘inertia’ of the power switch, which typically approximates to ¼ of the flyback oscillation period then this mechanism ensures the power switch turn on occurs close to the bottom of the flyback oscillation troughs. An extension of the present embodiment would be to use the existing FLY_QUART value as a delay following the point at which the FLY signal goes low. This with suitable delay compensation would give a very accurate indication of the bottom of the flyback trough.

The LeftBrane can be summarized as a circuit which interprets data provided on its FBD and FLY inputs to build up a detailed picture of the configuration and state of the switch mode power supply it is helping control and then passes appropriate power demand data on its DEMAND bus output to another part of the control circuit.

Thus broadly speaking, as described above, the function of LeftBrane is to interpret the state of the SMPS output voltage and determine whether it is above or below a required value, providing a DEMAND signal. The DEMAND signal (typically, for example, a binary signal) indicates whether more or less energy needs to be transferred to the SMPS output in order to maintain the correct output voltage. In preferred embodiments of a complete system the DEMAND signal is provided to the RightBrane system, which forms another part of the overall control system, but in other arrangements any circuit which provides a suitable signal may be employed. Broadly speaking the function of the RightBrane (or other circuit) is to control the SMPS in accordance with the DEMAND signal to regulate the output voltage.

For completeness, the RightBrane circuit (see again FIG. 2) will now be described in detail. The functional inputs and outputs of the RightBrane are shown in Table 3.

TABLE 3
RightBrane Functional Inputs and Outputs
Inputs

| | |
|---|---|
| DEMAND | Power Demand Indicator (from LeftBrane controller) |
| OCP | Over Current Protection error from analog comparator |
| | circuit |
| ZVSGO | qZVS Enable Trigger (from LeftBrane controller) |
| ZVS Mode Select | Zero Voltage Switching Mode Enable |
| CLK | System Clock input |
| RESET | Used as system reset |

Outputs

| | |
|---|---|
| CYCLE | Indicates start of new switching cycle to allow |
| | LeftBrane to synchronize with RightBrane |
| DRIVE | Output of RightBrane to Power Switch - used by |
| | LeftBrane to help determine correct FBD sampling |
| | point |

The key internal signals and sub-blocks within RightBrane are shown in FIG. 21.

RightBrane processes the DEMAND signal and calculates which one of eight pre-defined power levels should be deployed to best maintain the SMPS output at the required voltage. The power level value, PL, directly determines the pulse width and switching period for the DRIVE signal. DRIVE provides the input to a buffering gate driver block outside the scope of the present invention which in turn drives the gate of the power MOSFET (or similar high voltage switching device) which facilitates the transfer of energy into the SMPS transformer. In the present embodiment, DEMAND is implemented as a 2-bit bus, with the least significant bit used to represent the DEMAND state as described above and the most significant bit used to indicate an error condition (Over Temperature) which when active forces the system to the minimum power level. Unless specifically stated, the term DEMAND within this description refers only to the least significant bit.

Other signals provided by the LeftBrane to the RightBrane are as follows: ZVSGO indicates that the SMPS Flyback oscillation is at a trough value—or local minimum voltage. For high efficiency operation, RightBrane has a Quasi Zero Voltage Switching Mode, selected by the active-low ZVSEN_N input, in which the start of a new switching cycle is held back until a Flyback oscillation trough value is reached. OCP, or Over Current Protection, indicates that the current within the power switching device has reached a permitted maximum value and that the DRIVE signal to the switching device should be turned off immediately. CSBLANK is used to mask the OCP function, for a short time after the switching device is turned on, when the current is allowed briefly to exceed its limits to accommodate a permitted short current spike which can occur due to the leakage inductance within the SMPS transformer.

The present embodiment has eight discrete power levels. The power level currently in use is determined by the 3-bit PL bus. The PL bus value is derived from the most significant 3-bits of the output of the 6-bit power level ALU, PL_ALU. Each power switching cycle, PL_ALU is adjusted by a 6-bit, power level adjust value, PL_DELTA. An FIR process is applied to the DEMAND signal, to determine the required value for PL_DELTA.

The decision to derive eight discrete power levels from a 6-bit ALU was made in order to give a cost-effective solution with a high level of precision and a good dynamic response. However, this invention is fully applicable to other ALU sizes and numbers of power levels.

The present embodiment uses a 16-bit counter, RB_COUNT, which controls the timing of events within the RightBrane. It counts from zero up to the value of the period for the current power switching cycle. However, this invention is equally applicable to other sizes of counter.

FIG. 22 shows the timing relationship of RB_COUNT and all the key signals within the RightBrane.

RB_COUNT begins incrementing from zero at the start of a new power cycle when it has completed its count for the previous power cycle AND it is enabled by the ZVS_TRIG signal. FIG. 22 shows Quasi Zero Voltage Switching operation, selected by ZVSEN_N being in its active low state, where RB_COUNT is held at zero until the RightBrane receives a ZVSGO signal from the LeftBrane. The chain of events triggered by the arrival of ZVSGO is numbered 1 in FIG. 22. Note that ZVSGO is ignored unless the present switching cycle has completed. Number 12 in FIG. 22, shows one such arrival of ZVSGO.

FIG. 23 shows the circuit used to generate the ZVS_TRIG signal. Note that when Quasi-Zero Voltage Switching is not required, ZVSEN_N is forced to its inactive state, which in turn forces ZVS_TRIG into its active high state, which enables the next power switching cycle to commence as soon as the present one has completed.

FIG. 24 shows the operation of the RB_COUNT Switching Cycle Counter. It also shows how the CYCLE output is pulsed while RB_COUNT equals 2. This output is fed to the LeftBrane, where it is used to keep it in synchronization with the RightBrane. The timing of these events are numbered 2 in FIG. 22.

The internal version of the DRIVE signal, DRIVE_raw, is set into its active state by the combination of RB_COUNT being 0 and ZVS_TRIG being active. This internal signal stays high until the counter reaches the pulse width value, determined by the present power level. As DRIVE_raw goes active, RB_COUNT increments to 1 on the same clock edge. This is part of the sequence of events labelled 1 in FIG. 22. The setting and resetting of DRIVE_raw is shown in FIG. 25. The fall of DRIVE_raw is numbered 11 in FIG. 22.

The output version of the DRIVE signal differs from DRIVE_raw in that it is asynchronously forced inactive if an over current protection (OCP) condition is detected. When the asynchronously latched fersion of OCP called OCP_x is active, the DRIVE output is reset to its inactive state. FIG. 26 shows the gating of DRIVE_raw with the output of the Over Current Protection Latch, OCP_x, to create the output form of DRIVE.

Any OCP event seen is captured, if it is not being blanked by CSBLANK, and latched in the form of OCP_x. The events triggered by OCP are numbered 3 in FIG. 22. OCP_x remains active until the start of the next power switch cycle (RB_COUNT equals 0), numbered 4 in FIG. 22. This prevents any small glitches or re-firing of the DRIVE output caused by OCP clearing at its source before the end of the DRIVE pulse width. FIG. 27 shows the operation of the OCP_x latch.

The RightBrane takes the DEMAND input from the LeftBrane and uses it to determine the optimum on-time and frequency of the DRIVE signal for each power switching cycle. The data path for this is shown in FIG. 28.

DEMAND[0] is fed into a shift register, which is updated at the time RB_COUNT increments to 5, see the events numbered 5 in FIG. 22. The shift register is 2-bits deep in the present embodiment, but this invention is not restricted to that specific width. The bits in the shift register are combined with the current DEMAND[0] bit to form a DEMAND_HISTORY_VECTOR, which is 3-bits wide in this example. The DEMAND_HISTORY_VECTOR is used as the input to a look-up table which gives the power level adjustment value to be applied to the current power level ALU value to best maintain the SMPS regulation. The adjustments or deltas, PL_DELTA, are shown in Table 4. Note that the PL_ALU value is always adjusted up or down, unless it is at its maximum or minimum values. An overflow and underflow protection circuit prevents the PL_ALU from incrementing beyond its maximum value or from decrementing below zero, either of which would give erroneous results. The effective output power level PL value will only change when there is change which affects the 3-MSB's of PL_ALU.

TABLE 4
FIR Look-up Table for PL_Delta

| DEMAND History | PL_DELTA |
|---|---|
| 000 | −1 |
| 001 | −3 |
| 010 | −6 |
| 011 | −12 |
| 100 | 12 |
| 101 | 6 |
| 110 | 3 |
| 111 | 1 |

DEMAND_HISTORY VECTOR updates whenever either DEMAND changes (see the events numbered 10A in FIG. 22) or DEMAND_HISTORY updates (see the events numbered 10B in FIG. 22). It is the latter value which is used for the power level calculation in the following power switching cycle. Similarly, the PL_DELTA value updates one clock cycle after DEMAND_HISTORY_VECTOR (see the events numbered 9A and 9B in FIG. 22). Consequently it is the latter update which is added to the PL_ALU value in the following power switching cycle.

The new power level is calculated as the RightBrane counter, RB_COUNT, increments to 4 (see the events numbered 6 in FIG. 22), before the next DEMAND value is captured. If the current DEMAND is MIN_PL due to an OTP condition, then the power level immediately drops to the minimum power level of 0. Otherwise the power level adjustment, PL_DELTA, is added to the current power level ALU value (PL_ALU). There is a one clock cycle delay between PL_ALU and PL. This is shown in 7 in FIG. 22.

The resulting 3-bit power level, PL, is then used in the lookup table for the period and pulse_width values for the DRIVE signal. The lookup tables' contents are shown in Table 5, with an alternative implementation with a greater range of power shown in Table 6 (see below) The new values for the pulse width and switching cycle period are updated the clock cycle after PL is updated. See number 8 in FIG. 22.

The on-time and cycle-time for each power level are defined in terms of digital clock periods, with values chosen to give power levels that are spaced logarithmically. Tables 3 and 4 additionally give an indication of the relative power delivered. The data in Table 4 is also represented in graphical form as a ‘power curve’ in FIG. 29.

TABLE 5
Power Level Table

| Power Level | CYCLE count | ON count | Relative Power |
|---|---|---|---|
| 0 | 1024 | 4 | 0.20% |
| 1 | 420 | 4 | 0.48% |
| 2 | 172 | 4 | 1.16% |
| 3 | 110 | 5 | 2.83% |
| 4 | 88 | 7 | 6.90% |
| 5 | 60 | 9 | 16.82% |
| 6 | 43 | 12 | 41.02% |
| 7 | 32 | 16 | 100.00% |

TABLE 6
Power Level Table - An alternative embodiment

| Power Level | CYCLE count | ON count | Relative Power |
|---|---|---|---|
| 0 | 8191 | 4 | 0.02% |
| 1 | 2496 | 4 | 0.08% |
| 2 | 761 | 4 | 0.26% |
| 3 | 232 | 4 | 0.86% |
| 4 | 110 | 5 | 2.83% |
| 5 | 66 | 7 | 9.29% |
| 6 | 50 | 11 | 30.48% |
| 7 | 32 | 16 | 100.00% |

The RightBrane can be summarized as a circuit which analyses data provided on its DEMAND bus input and selects the appropriate power switch on times and power switch frequency values to correctly regulate the output of the switch mode power supply it is helping to control.

No doubt many other effective alternatives will occur to the skilled person. It will be understood that the invention is not limited to the described embodiments and encompasses modifications apparent to those skilled in the art lying within the spirit and scope of the claims appended hereto.

1. A control system for a switch mode power supply (SMPS), the SMPS having a input side for receiving a power supply input and an output side for providing a dc output voltage, said input and output side of said SMPS being coupled by a transformer, the control system having two operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer, said control system having a feedback input to receive a said feedback signal, a control output for regulating said output voltage, and a mode selector coupled to said feedback input to select one of said first and second control system operating modes responsive to said feedback signal.

2. A control system as claimed in claim 1 wherein said mode selector is configured to digitise said feedback signal to provide a first digitised feedback signal (FLY) and to select a said operating mode responsive to detection of the presence or absence of one or more transitions of said first digitised feedback signal.

3. A control system as claimed in claim 1 wherein said mode selector is configured to select a said operating mode responsive to a level of said feedback signal with respect to a zero volts reference level.

4. A control system as claimed in claim 1 wherein said control output is responsive to a value of said feedback signal at a sampling time, and wherein said control system is configured to select said sampling time responsive to said operating mode.

5. A control system as claimed in claim 4 wherein in said first operating mode said sampling time corresponds to a time when a current in an input side winding of said transformer is substantially at a peak value, and wherein in said second mode said sampling time corresponds to a time having a substantially fixed backwards offset from a time when a current is an output side winding of said transformer is substantially zero.

6. A control system as claimed in claim 5 wherein said SMPS includes a switching device for switching power to said input side winding of said transformer in repeated power switching cycles of said SMPS, and wherein said control system has an input from a drive signal to said switching device, said control system further comprising sampling time determination system coupled to said feedback input and to said drive signal input and configured to determine said sampling time in said first mode from said drive signal and said sampling time in said second mode from said feedback signal.

7. A control system as claimed in claim 4 wherein said control output (DEMAND) comprises a digital signal output, the control system further comprising a comparator coupled to said feedback input to compare a signal from said feedback input with a reference to provide a second digitised feedback signal (FBD), and wherein said digital signal output is responsive to a value of said second digitised feedback signal at said sampling time.

8. A control system as claimed in claim 1 further comprising a current sense input to receive a current sense signal (CS), and wherein in said first mode said control output is responsive to both said feedback signal and said current sense signal.

9. A control system for a switch mode power supply, the SMPS having a input side for receiving a power supply input and an output side for providing a dc output voltage, said input and output side of said SMPS being coupled by a transformer, the control system having a feedback input to receive a feedback signal (FB) responsive to a voltage in said output side of said SMPS, and a control output to provide a control signal (DEMAND) for, regulating said dc output voltage, the control system further comprising a first comparator coupled to said feedback input to compare a signal from said feedback input with a first reference level to provide a first digitised signal (FLY), and a second comparator with a second reference level to provide a second digitised signal (FBD), and a control system to provide said control signal responsive to said first and second digitised signals.

10. A control system as claimed in claim 9 wherein said control system is configured to provide said control signal output responsive to a value of said second digitised signal at a sampling time, and wherein said sampling time is dependent upon said first digitised control signal.

11. A control system as claimed in claim 11 further comprising a first store coupled to an output of said first comparator to store a history of said first digitised signal, and wherein said sampling time is dependent upon said first digitised signal history.

12. A control system as claimed in claim 11 further comprising a second store coupled to an output of said second comparator to store a history of said second digitised signal, and wherein said sampling time is dependent upon said second digitised signal history.

13. A control system as claimed in claim 9 further configured to select of a plurality of SMPS output regulation operating modes responsive to said feedback signal.

14. A control system as claimed in claim 9 further comprising a current sense input to receive a current signal (CS), and wherein said second comparator is further coupled to said current sense input to compare a combination of said feedback signal, said current sense signal and second said reference level to generate said second digitised signal.

15. A switch mode power supply (SMPS) controller for a SMPS having an input side for receiving a power supply input and an output side for providing a dc output voltage, said input and output sides of said SMPS being coupled by a transformer, the controller having two operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer.

16. A switch mode power supply including a control system as claimed in claim 1.

17. A switch mode power supply including a control system as claimed in claim 9.

18. A method of implementing a control system for a switch mode power supply (SMPS), the SMPS having a input side for receiving a power supply input and an output side for providing a dc output voltage, said input and output side of said SMPS being coupled by a transformer, the method comprising:
providing two control system operating modes, a first mode for regulating an output voltage of the power supply responsive to a feedback signal derived from a dc voltage on said power supply output side dependent upon said output voltage, and a second mode for regulating an output voltage of the power supply responsive to a feedback signal derived from an auxiliary winding of said transformer;
receiving a said feedback signal;
selecting one of said first and second control system operating modes responsive to said feedback signal; and
outputting a control signal for regulating said SMPS output voltage to implement said control system in accordance with said selected operating mode.

19. A control system for a switch mode power supply (SMPS), the SMPS having an input side for receiving a power supply input and an output side for providing a dc output voltage, said input and output sides of said SMPS being coupled by an energy transfer device, said control system having a feedback input to receive a feedback signal responsive to said dc output voltage, and a control output for regulating said output voltage, said control system further comprising a current sense input to receive a current sense signal, and wherein said control system is configured to output a control signal dependent upon a combination of said feedback signal and said current sense signal for regulating said output voltage.

20. A control system as claimed in claim 19 wherein said SMPS operates in a continuous conduction mode.

21. A control system as claimed in claim 19 further comprising a comparator coupled to said feedback input and to said current sense input to determine whether said combination is above or below a reference level and provide a comparator output signal, and wherein said control signal is responsive to said comparator output signal.

22. A control system as claimed in claim 21 further comprising a timing generator to generate a sampling signal indicating times when energy stored in said energy transfer device is substantially at a maximum, and wherein said control system is responsive to a value of said comparator output signal at said indicated times.

23. A switch mode power supply including a control system as claimed in claim 19.

24. A switch mode power supply including a controller as claimed in claim 15.

25. A method of controlling a switch mode power supply (SMPS), the SMPS having an input side for receiving a power supply input and an output side for providing a de output voltage, said input and output sides of said SMPS being coupled by an energy transfer device, the method comprising:
receiving a feedback signal responsive to said de output voltage;
receiving a current sense signal responsive to a current flowing in said SMPS input side and providing power to said energy transfer device; and
controlling said SMPS output voltage responsive to a combination of said feedback signal and said current sense signal.

26. A method as claimed in claim 25 wherein said controlling comprises controlling said SMPS to operate in a continuous conduction mode.
